(19) United States
(12) Patent Application Publication
(10) Pub. No.: US 2022/0191594 A1
(43) Pub. Date: Jun. 16, 2022

(54) SOCIAL NETWORK LIVE EVENTS

(71) Applicant: Facebook, Inc., Menlo Park, CA (US)

(72) Inventors: Joseph Paul Devoy, III, New York, NY (US); Benji Renzo Kuroda, New York, NY (US); Jason Scott Brooks, Hewlett, NY (US)

(21) Appl. No.: 17/247,564

(22) Filed: Dec. 16, 2020

(51) Int. Cl. H04N 21/478; H04L 12/58; H04L 29/08; H04N 21/2187; H04N 21/4788; H04N 21/458; G06Q 50/00; G06Q 30/06; G06Q 20/38; G06Q 20/12; G06Q 10/10

(52) U.S. Cl. CPC H04N 21/47815; H04L 51/32; H04L 67/306; H04L 67/22; H04N 21/2187; H04N 21/4788; G06Q 10/109; G06Q 50/01; G06Q 30/0641; G06Q 30/0633; G06Q 30/0617; G06Q 20/384; G06Q 20/12; H04N 21/458

(57) ABSTRACT

Techniques are described for a social networking system to provide an interactive live stream event. In some cases, the social networking system may be configured to allow a user to both view a live stream event while preforming other operations associated with the social networking system, such as reviewing items, providing comments, and completing purchase transactions.

### BACKGROUND

Social networking systems provide users with functionality to share live events with other users, such as via a live stream and/or recorded video. Most conventional live stream functionality on social networking systems, however, is not compatible with other functionality provided by a social networking system on a social network application, and requires that a user leaves a live stream (or the social network application entirely) to access this other functionality. Therefore, users may be discouraged from viewing live stream events due to the difficulty with accessing other functionality of the social network application during a live stream event.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a view of an example system usable to assist with live stream events, according to some implementations.

FIG. 2 is an example illustrating scheduling interfaces associated with scheduling a live stream event according to some implementations.

FIG. 3 is an example illustrating a streaming interface associated with a live stream event according to some implementations.

FIG. 4 is an example illustrating a viewing interface associated with a live stream event according to some implementations.

FIG. 5 is an example illustrating a shopping interface associated with a live stream event according to some implementations.

FIG. 6 is another example illustrating a shopping interface associated with a live stream event according to some implementations.

FIG. 7 is an example illustrating shopping interfaces associated with a live stream event according to some implementations.

FIG. 8 is an example illustrating viewing interfaces associated with a live stream event according to some implementations.

FIG. 9 is an example illustrating event summary interfaces associated with a live stream event according to some implementations.

FIG. 10 is a flow diagram illustrating an example process for initiating a live stream event via the social networking system according to some implementations.

FIG. 11 is a flow diagram illustrating an example process associated with a host user highlighting an item featured in a live stream event, according to some implementations.

FIG. 12 is a flow diagram illustrating an example process associated with a host user recognizing viewing users during a live stream event, according to some implementations.

FIG. 13 is a flow diagram illustrating an example process associated with a viewing user consuming live stream event content, according to some implementations.

FIG. 14 is an example system and device that is usable to implement the techniques described herein according to some implementations.

### DETAILED DESCRIPTION

Social networking systems and websites are often used to promote products, items, and merchandise. However, many of the conventional systems are directed to assisting social network users in promoting and providing information related to products in the form of static content, such as pre-recorded videos and images as well as fixed textual content in the forms of posts. In the conventional systems, the static content is typically supplemental to a product or item page that users are required to access in order to purchase the item. In these situations, users are typically forced to investigate or learn about a product via the static educational content (which may be at one or more location) and subsequently navigate to another listing, page, or even system to complete a purchase the item or product.

The social networking system, discussed herein, is configured to allow creators to generate interactive live content that provides users of the social networking system with functionality to consume the educational live content and to purchase the item or items associated with the educational content without pausing or leaving the live content stream. Thus, the social network system, discussed herein, requires fewer processing and network resources in regard to producing educational content, post creation, and product purchasing than comparable conventional social networking systems.

In some implementations, the social networking system may include an interface to allow a host user (or creator) to schedule a live stream event for a future time. In some instance, the host user may both schedule the live stream event and select items or topics that will be featured or otherwise discussed during the event. The social network system may then identify other users of the social networking system that may be interested in or are likely to attend the live stream event. For example, the social networking system may identify the users based on features associated with the host user (e.g., users that have followed, liked, or consumed the content of the host user, and the like), features associated with the other users (e.g., historical data, historical content consumptions, known likes or dislikes, past purchasing behavior, likelihood to purchase the item, and the like), the times or topics selected for the live stream event, time/day of the event (e.g., weekday v. weekend, after work hours based on a current time zone of the user, and the like), etc.

The social network system may then send a notification to the identified or selected users. The notification may indicate or include a link to access the live stream event as well as information related to the topic, items, creator or host user, and stream time. In some cases, the notification may allow the selected users to bookmark, set reminders, and otherwise share or invite additional users to the live stream event.

During the live stream event, the users may be able to view the live stream content, add comments (that may be visible to other users and/or the host user). The users may also be able to access a shopping interface that includes the items selected by the host user to feature during the live stream event. In some cases, the users may add the items to a shopping cart from the shopping interface and/or purchase the items via the shopping cart while consuming the live stream content.

In some cases, the host user may be able to add and/or remove items from the shopping interface during the live stream event. For example, the host user may diverge from a planned script and begin to discuss an item not pre-selected or pre-loaded into the shopping interface. In this example, the host user may access a list of items that the host user has previously selected in past live streams events, are commonly selected by the host user, and/or a pre-loaded list of potential items. The host user may then select the additional item to add and/or select the item to be removed from the shopping interface while the stream is active.

In one implementation, the host user may receive feedback from the social network system as to the viewers. For instance, the host user may receive feedback as to an identity of the user, an identity of items purchased or placed in the shopping cart, and a number of each item purchased or placed in the shopping cart. In this implementation, the host user may be able to thank, recognize, or otherwise respond to the feedback during the live stream event in a manner that the recognition is displayed publicly to all active consumers of the live stream event. For example, if a first user purchases seven units of an item during the live stream event, the host user may receive the feedback from the social networking system as part of a feedback feed. The host user may then be able to tap or select the feedback associated with the first user to cause the social networking system to display, as part of the live stream, a preloaded message (e.g., thank you for your support first user) that may appear in, for instance, a comment section of the live stream event. In this manner, the host user can publicly acknowledge support by viewers, purchasers, and the like.

In some cases, the social network system may provide additional information associated with the feedback to the host user. For example, the social network system may display a frequency of attendance of the first user with respect to the live stream events associated with the host user, a metric associated with historical purchases of the items associated with the host user items by the first user, a total cost of the items purchased during the live stream event, a number of other users invited and/or attending the live stream event by the first user, and the like. In one specific example, the feedback may be coded (such as color coded) so that the host user can quickly comprehend the status of the feedback and respond while continuing to conduct the live stream event. For example, positive feedback may be green while negative feedback may be red, and the like.

After the lives stream event ends, the users may receive a summary as to items in the shopping cart and/or a list of items purchased during the live stream event. In some cases, the summary may include a list of items available during the live stream event, a list of items discussed during the live stream event, a most popular item from the live stream event, a least popular item from the live stream event, a metric associated to the feedback, number of purchases, and the overall reception of the lives stream event.

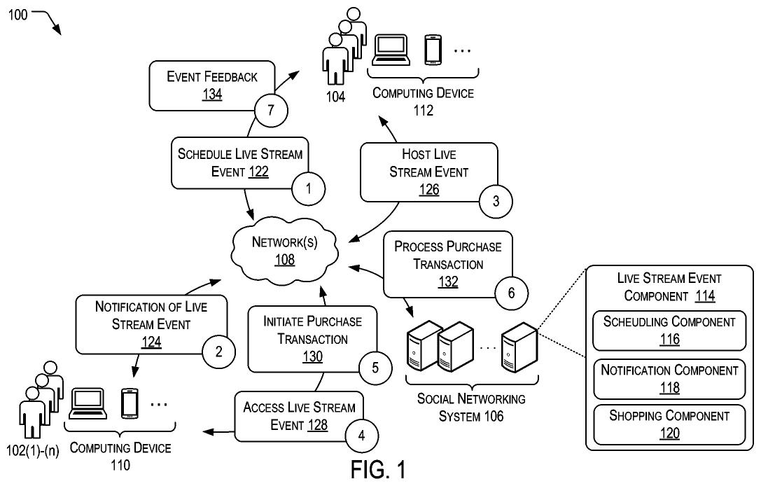

FIG. 1 is a view of an example system usable to assist with live stream events, according to some implementations. In some examples, the system 100 may include users 102(1)-102(n) (collectively “users 102”) and/or a host user 104 to interact with a social networking system 106 via a network 108 using computing devices, generally indicated by 110 and 112. In some cases, the host user 104 may be more than one host user, but is referred to herein as a single host user for clarity.

In the illustrated example, the social networking system 106 may include a live stream event component 114. The live stream event component 114 may include a number of sub-components or modules, such as a scheduling component 116, a notification component 118, and a shopping component 120. The live stream component 114 may provide the host user 104 with functionality to stream or host the live stream event and the users 102 viewing the live stream event to interact with the social networking system 106 as well as each other. For example, the live stream component 114 may allow the user 104 hosting the live stream event to highlight items, respond to feedback (e.g., acknowledge a comment or purchase), add and remove items from the shopping interface, and the like. The users 102 viewing the live stream event may also interact with the social networking system 106 via the live stream component 114, such as by providing feedback, consuming the stream, reviewing the items and/or information associated with the items, and the like.

The scheduling component 116 may be configured to provide functionality to a host user to schedule a live stream event via the social networking system 106. For example, the host user may be able to set a time and date for the lives stream event as well as to select featured items and/or collections that will be discussed (or otherwise shared) and available to purchase during the live stream event.

The notification component 118 may be configured to send alerts and/or notifications to users 102 in response to the host user 104 scheduling a live stream event via the scheduling component 116. For example, the notifications may include access information for the users 102 to access the live stream, sharing instructions, time of event, as well as other event information (such as the topic or items associated therewith).

The shopping component 120 may allow the users 102 to place the items into the shopping chart via the shopping interface and to subsequently purchase the items. In this example, the users 102 may both add the items to a personal shopping cart and complete a purchase event via the social networking system 106 while continuously consuming the live stream event hosted by the host user 104.

For instance, in the illustrated example, the host user 104 may, at operation 122 (indicated by “1”), schedule or generate a live stream event. For example, the host user 104 may schedule a time for the event as well as select a topic and/or one or more items to be featured with respect to the live stream event. In some cases, the host user 104 may select a set of items and associated purchase prices and descriptive information that will be discussed and available for purchase during the live stream event. In some cases, the host user 104 may also generate a list of additional items (again with associated prices and/or descriptive information) that may be added to the shopping interface during the live stream event, even if the additional items are not discussed during the live stream event.

In the illustrated example, at operation 124, (indicated by “2”), the user 102 may receive a notification of the live stream event from the social networking system 106. For example, the notification components 118 of the social networking system 106 may determine a set of users 102 whom may be interested in attending the live stream event and send a notification to each of the users 102. For example, the users 102 may be selected based on features associated with the host user or creator (e.g., users that have followed, liked, or consumed the content of the host user, and the like), features associated with the users (e.g., historical data, historical content consumptions, likes or dislikes that a user has shared with the social networking system 106, past purchasing behavior, likelihood to purchase the item, and the like), the times or topics selected for the live stream event, time/day of the event (e.g., weekday v. weekend, after work hours based on a current time zone of the user, and the like), etc. in some cases, one or more of the users 102 may receive the notification at the request of another of the users 102. For instance, a first user may forward or otherwise send or cause the notification to be sent to additional users that the first user believes may be interested in attending the live stream event.

Next, at operation 126 (indicated by “3”), the host user 104 may host or otherwise initiate the live stream event and, at operation 128 (indicated by “4”), the users 102 may access the live stream event. For example, the live stream event may initiate in response to an input by the host user 104. In other examples, the live stream event may be initiated by the social networking system 106 in response to an occurrence of a scheduled time. In some cases, when the event initiates, a user 102 may view a stream of image, video, and/or audio data from the host users, in this case, the host user 104.

In the current example, at operation 130 (indicated by “5”), one or more of the users 102 may initiate a purchase transaction via the social networking system 106. For example, a first user 102(1) may select an item being discussed during the live stream event by the host user 104. The shopping component 120 of the social networking system 106 may cause the selected item to be placed in a shopping cart associated with the first user 102(1). The first user 102(1) may then authorize a purchase of the item (or items) in the shopping cart associated with the first user 102(1) all while concurrently consuming the live stream event content.

Then, at operation 132 (indicated by “6”), the shopping component 120 of the social networking system 106 may process the transaction on behalf of the first user 102(1). For instance, the shopping component 120 may order the item from a third-party vendor on behalf of the first user 102(1) and/or authorize a charge to a stored payment method associated with the first user 102(1) or an account of the first user 102(1). In the current example, the first user 102(1) may place the item in the shopping cart and complete the transaction via the social networking system 106 while continuously consuming the live stream content being streamed from a device 112 associated with the host user 104.

In this example, at operation 134 (indicated by “7”), the host user 104 may receive feedback. For instance, the social networking system 106 may cause feedback associated with the purchase placed by the first user 102(1) to appear on a display the device 112 associated with the host user 104 or an audio signal to output via a speaker of the device 112. In some cases, the feedback may include an identity of the user 102(1), an identity of items purchased or placed in the shopping cart, a number of each item purchased or placed in the shopping cart, a total purchase price associated with the item or items purchased, and the like.

In some cases, the social networking system 106 may provide additional information associated with the feedback to the host user 104. For example, the social network system 106 may display a frequency of attendance of the first user 102(1) with respect to hosts' live stream events, a metric associated with historical purchases of the first user 102(1), a number of other users invited by and/or attending the live stream event because the first user 102(1), and the like. In one specific example, the feedback may be coded (such as color coded) so that the host user 104 may quickly comprehend the status of the feedback and respond while continuing to conduct the live stream event. For example, positive feedback may be green while negative feedback may be red, and the like. In another example, the feedback may be green if the purchases or other support of the first user 102(1) exceeds a threshold (such as a threshold purchase price, a threshold number of items, a threshold number of different items, a threshold number of other users invited to the live stream event, an attendance threshold, and the like). In some cases, the host user 104 may specify or otherwise define the thresholds and/or any status indictors associated with the feedback during a live stream event scheduling phase or step.

In some cases, the host user 104 may be able to thank, recognize, or otherwise respond to the feedback during the live stream event in a manner that the recognition is displayed publicly to all (or multiple) active consumers of the live stream event. For example, if a first user 102(1) purchases seven units of an item during the live stream event, the host user 104 may receive the feedback from the social networking system 106. The host user 104 may then be able to tap or select the feedback associated with the first user 102(1) to cause the social networking system 106 to display, as part of the live stream, a preloaded message, icon, or the like that may appear in, for instance, a comment section of the live stream event. In this manner, the host user 104 may publicly acknowledge the purchases and/or support of the first user 102(1).

In the illustrated example, each of the computing devices 110 and 112 may include one or more processors and memory storing computer executable instructions to implement the functionality discussed herein attributable to the various computing devices. In some examples, the computing devices 110 and 112 may include desktop computers, laptop computers, tablet computers, mobile devices (e.g., smart phones or other cellular or mobile phones, mobile gaming devices, portable media devices, etc.), or other suitable computing devices. The computing devices 110 and 112 may execute one or more client applications, such as a web browser (e.g., Microsoft Windows Internet Explorer, Mozilla Firefox, Apple Safari, Google Chrome, Opera, etc.) or a native or special-purpose client application (e.g., social media applications, messaging applications, email applications, games, etc.), to access and view content over the network 108.

The network 108 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which the computing devices 110 and 112 may access the social networking system 106 and/or communicate with one another.

The social networking system 106 may include one or more servers or other computing devices, any or all of which may include one or more processors and memory storing computer executable instructions to implement the functionality discussed herein attributable to the social networking system or digital platform. The social networking system 106 may enable its users 102 and 104 (such as persons or organizations) to interact with the social networking system 106 and with each other via the computing devices 110 and 112. The social networking system 106 may, with input from a user, create and store in the social networking system 106 a user account associated with the user. The user account may include demographic information, communication-channel information, and information on personal interests of the user. The social networking system 106 may also, with input from a user, create and store a record of relationships of the user with other users of the social networking system 106, as well as provide services (e.g., posts, comments, photo-sharing, messaging, tagging, mentioning of other users or entities, games, etc.) to facilitate social interaction between or among the users.

In some examples, the social networking system 106 may provide privacy features to the users 102 and 104 while interacting with the social networking system 106. In particular examples, one or more objects (e.g., content or other types of objects) of the system 106 may be associated with one or more privacy settings. The one or more objects may be stored on or otherwise associated with any suitable computing system or application, such as, for example, the social networking system 106, a client system, a third-party system, a social networking application, a messaging application, a photo-sharing application, or any other suitable computing system or application. Although the examples discussed herein are in the context of an online social network, these privacy settings may be applied to any other suitable computing system. Privacy settings (or “access settings”) for an object or item of content may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular examples, privacy settings for an object may specify a “blocked list” and/or a “restricted list” of users or other entities that should not be allowed to access certain information associated with the object. In particular examples, the blocked list may include third-party entities. The blocked list or restricted list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular examples, privacy settings may allow users to opt in to or opt out of having their content, information, or actions stored/logged by the social-networking system or shared with other systems (e.g., a third-party system). Although this disclosure describes using particular privacy settings in a particular manner, this disclosure contemplates using any suitable privacy settings in any suitable manner.

In particular examples, privacy settings may be based on one or more nodes or edges of a social graph. A privacy setting may be specified for one or more edges or edge-types of the social graph, or with respect to one or more nodes or node-types of the social graph. The privacy settings applied to a particular edge connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example and not by way of limitation, a user, such as a user 102 and 104, may share an object to the social networking system 106. The object may be associated with a concept node connected to a user node of the user 102 and/or 104 by an edge. The user 102 and/or 104 may specify privacy settings that apply to a particular edge connecting to the concept node of the object, or may specify privacy settings that apply to all edges connecting to the concept node. In some examples, the user 102 and/or 104 may share a set of objects of a particular object-type (e.g., a set of images). The user 102 and/or 104 may specify privacy settings with respect to all objects associated with the user 102 and/or 104 of that particular object-type as having a particular privacy setting (e.g., specifying that all images posted by the user 102 and/or 104 are visible only to friends of the user and/or users tagged in the images).

In particular examples, the social networking system 106 may present a “privacy wizard” (e.g., within a webpage, a module, one or more dialog boxes, or any other suitable interface) to the user 102 and/or 104 to assist the user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular examples, the social networking system 106 may offer a “dashboard” functionality to the user 102 and/or 104 that may display, to the user 102 and/or 104, current privacy settings of the user 102 and/or 104. The dashboard functionality may be displayed to the user 102 and/or 104 at any appropriate time (e.g., following an input from the user 102 and/or 104 summoning the dashboard functionality, following the occurrence of a particular event or trigger action). The dashboard functionality may allow the user 102 and/or 104 to modify one or more of the user's current privacy settings at any time, in any suitable manner (e.g., redirecting the user 102 and/or 104 to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, one or more servers of the social networking system 106 may be authorization/privacy servers for enforcing privacy settings. In response to a request from the user 102 and/or 104 (or other entity) for a particular object stored in a data store, the social networking system 106 may send a request to the data store for the object. The request may identify the user 102 and/or 104 associated with the request and the object may be sent only to the user 102 and/or 104 (or a client system of the user) if the authorization server determines that the user 102 is authorized to access the object based on the privacy settings associated with the object. If the requesting user is not authorized to access the object, the authorization server may prevent the requested object from being retrieved from the data store or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular examples, an object may represent content that is visible to a user through a newsfeed of the user. As an example and not by way of limitation, one or more objects may be visible to a user's “Trending” page. In particular examples, an object may correspond to a particular user. The object may be content associated with the particular user, or may be the particular user's account or information stored on the social networking system 106, or other computing systems. As an example and not by way of limitation, the user 102 and/or 104 may view one or more other users 102 and/or 104 of an online social network through a “People You May Know” function of the online social network, or by viewing a list of friends of the user 102. As an example and not by way of limitation, the user 102 and/or 104 may specify that they do not wish to see objects associated with a particular other user (e.g., the user 102 and/or 104) in their newsfeed or friends list. If the privacy settings for the object do not allow it to be surfaced to, discovered by, or visible to the user 102 and/or 104, the object may be excluded from the search results. Although this disclosure describes enforcing privacy settings in a particular manner, this disclosure contemplates enforcing privacy settings in any suitable manner.

In particular examples, different objects of the same type associated with a user may have different privacy settings. Different types of objects associated with a user may also have different types of privacy settings. As an example and not by way of limitation, the user 102 and/or 104 may specify that the user's status updates are public, but any images shared by the user are visible only to the user's friends on the online social network. In some examples, the user 102 and/or 104 may specify different privacy settings for different types of entities, such as individual users, friends-of-friends, followers, user groups, or corporate entities. In some examples, the user 102 and/or 104 may specify a group of users that may view videos posted by the user 102 and/or 104, while keeping the videos from being visible to the user's employer. In particular examples, different privacy settings may be provided for different user groups or user demographics. As an example and not by way of limitation, the user 102 and/or 104 may specify that other users who attend the same university as the user 102 and/or 104 may view the user's pictures, but that other users who are family members of the user 102 and/or 104 may not view those same pictures.

In particular examples, the social networking system 106 may provide one or more default privacy settings for each object of a particular object-type. A privacy setting for an object that is set to a default may be changed by a user associated with that object. As an example and not by way of limitation, all images posted by the user 102 and/or 104 may have a default privacy setting of being visible only to friends of the first user and, for a particular image, the user 102 and/or 104 may change the privacy setting for the image to be visible to friends and friends-of-friends.

In particular examples, privacy settings may allow the user 102 and/or 104 to specify (e.g., by opting out, by not opting in) whether the social networking system 106 may receive, collect, log, or store particular objects or information associated with the user 102 and/or 104 for any purpose. In particular examples, privacy settings may allow the user 102 and/or 104 to specify whether particular applications or processes may access, store, or use particular objects or information associated with the user. The privacy settings may allow the user 102 and/or 104 to opt in or opt out of having objects or information accessed, stored, or used by specific applications or processes. The social networking system 106 may access such information in order to provide a particular function or service to the user 102 and/or 104, without the social networking system 106 having access to that information for any other purposes. Before accessing, storing, or using such objects or information, the social networking system 106 may prompt the user 102 and/or 104 to provide privacy settings specifying which applications or processes, if any, may access, store, or use the object or information prior to allowing any such action. As an example and not by way of limitation, the user 102 and/or 104 may transmit a message to the user 102 and/or 104 via an application related to the online social network (e.g., a messaging app), and may specify privacy settings that such messages should not be stored by the social networking system 106.

In particular examples, the user 102 and/or 104 may specify whether particular types of objects or information associated with the user 102 and/or 104 may be accessed, stored, or used by the social networking system 106. As an example, and not by way of limitation, the user 102 and/or 104 may specify that images sent by the user 102 and/or 104 through the social networking system 106 may not be stored by the social networking system 106. In some examples, the user 102 and/or 104 may specify that messages sent from the user 102 and/or 104 to another user may not be stored by the social networking system 106. In some cases, the user 102 and/or 104 may specify that all objects sent via a particular application may be saved by the social networking system 106.

In particular examples, privacy settings may allow the user 102 and/or 104 to specify whether particular objects or information associated with the user 102 and/or 104 may be accessed from particular client systems or third-party systems. The privacy settings may allow the user 102 and/or 104 to opt in or opt out of having objects or information accessed from a particular device (e.g., the phone book on a user's smart phone), from a particular application (e.g., a messaging app), or from a particular system (e.g., an email server). The social networking system 106 may provide default privacy settings with respect to each device, system, or application, and/or the user 102 and/or 104 may be prompted to specify a particular privacy setting for each context. As an example, and not by way of limitation, the user 102 and/or 104 may utilize a location-services feature of the social networking system 106 to provide recommendations for restaurants or other places in proximity to the user 102 and/or 104. The default privacy settings of the user 102 and/or 104 may specify that the social networking system 106 may use location information provided from the computing device 110 and/or 112 of the user 102 and/or 104 to provide the location-based services, but that the social networking system 106 may not store the location information of the user 102 and/or 104 or provide it to any third-party systems. The user 102 and/or 104 may then update the privacy settings to allow location information to be used by a third-party image-sharing application in order to geo-tag photos.

In particular examples, privacy settings may allow a user to engage in the ephemeral sharing of objects on the online social network. Ephemeral sharing refers to the sharing of objects (e.g., posts, photos) or information for a finite period of time. Access or denial of access to the objects or information may be specified by time or date. As an example, and not by way of limitation, a user may specify that a particular image uploaded by the user is visible to the user's friends for the next week, after which time the image may no longer be accessible to other users. In some examples, a company may post content related to a product release ahead of the official launch and specify that the content may not be visible to other users until after the product launch.

In particular examples, for particular objects or information having privacy settings specifying that they are ephemeral, the social networking system 106 may be restricted in its access, storage, or use of the objects or information. The social networking system 106 may temporarily access, store, or use these particular objects or information in order to facilitate particular actions of a user associated with the objects or information, and may subsequently delete the objects or information, as specified by the respective privacy settings. As an example, and not by way of limitation, the user 102 may transmit a message to the user 104, and the social networking system 106 may temporarily store the message in a data store until the user 104 has viewed or downloaded the message, at which point the social networking system 106 may delete the message from the data store. In some examples, continuing with the prior example, the message may be stored for a specified period of time (e.g., 2 weeks), after which point the social networking system 106 may delete the message from the data store.

In particular examples, changes to privacy settings may take effect retroactively, affecting the visibility of objects and content shared prior to the change. As an example, and not by way of limitation, the user 102 may share a first image and specify that the first image is to be public to all other users. At a later time, the user 102 and/or 104 may specify that any images shared by the user should be made visible only to a first user group. The social networking system 106 may determine that this privacy setting also applies to the first image and make the first image visible only to the first user group. In particular examples, the change in privacy settings may take effect only going forward. Continuing the example above, if the user 102 and/or 104 changes privacy settings and then shares a second image, the second image may be visible only to the first user group, but the first image may remain visible to all users. In particular examples, in response to a user action to change a privacy setting, the social networking system 106 may further prompt the user to indicate whether the user wants to apply the changes to the privacy setting retroactively. In particular examples, a user change to privacy settings may be a one-off change specific to one object. In particular examples, a user's change to privacy may be a global change for all objects associated with the user.

In particular examples, the social networking system 106 may determine that user 102 and/or 104 may want to change one or more privacy settings in response to a trigger action associated with the user 102 and/or 104. The trigger action may be any suitable action on the online social network. As an example, and not by way of limitation, a trigger action may be a change in the relationship between a first and second user of the online social network (e.g., “un-friending” a user, changing the relationship status between the users, etc.). In particular examples, upon determining that a trigger action has occurred, the social networking system 106 may prompt the user 102 and/or 104 to change the privacy settings regarding the visibility of objects associated with the user 102 and/or 104. The prompt may redirect the user 102 and/or 104 to a workflow process for editing privacy settings with respect to one or more entities associated with the trigger action. The privacy settings associated with the user 102 and/or 104 may be changed only in response to an explicit input from the user 102 and/or 104, and may not be changed without the approval of the user 102 and/or 104. As an example, and not by way of limitation, the workflow process may include providing the user 102 with the current privacy settings with respect to the user 104 or to a group of users (e.g., un-tagging the user 102 or the user 104 from particular objects, changing the visibility of particular objects with respect to the user 104 or a group of users), and receiving an indication from the user 102 to change the privacy settings based on any of the methods described herein, or to keep the existing privacy settings.

In particular examples, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example, and not by way of limitation, a user's default privacy settings may indicate that a person's relationship status is visible to all users (i.e., “public”). However, if the user changes his or her relationship status, the social networking system 106 may determine that such action may be sensitive and may prompt the user to confirm that his or her relationship status should remain public before proceeding. In some examples, a user's privacy settings may specify that the user's posts are visible only to friends of the user. However, if the user changes the privacy setting for his or her posts to being public, the social networking system 106 may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular examples, a user may need to provide verification of a privacy setting on a periodic basis. A prompt or reminder may be periodically sent to the user based either on time elapsed or a number of user actions. As an example, and not by way of limitation, the social networking system 106 may send a reminder to the user to confirm his or her privacy settings every six months or after every ten photo posts. In particular examples, privacy settings may also allow users to control access to the objects or information on a per-request basis. As an example and not by way of limitation, the social networking system 106 may notify the user whenever a third-party system attempts to access information associated with the user, and require the user to provide verification that access should be allowed before proceeding.

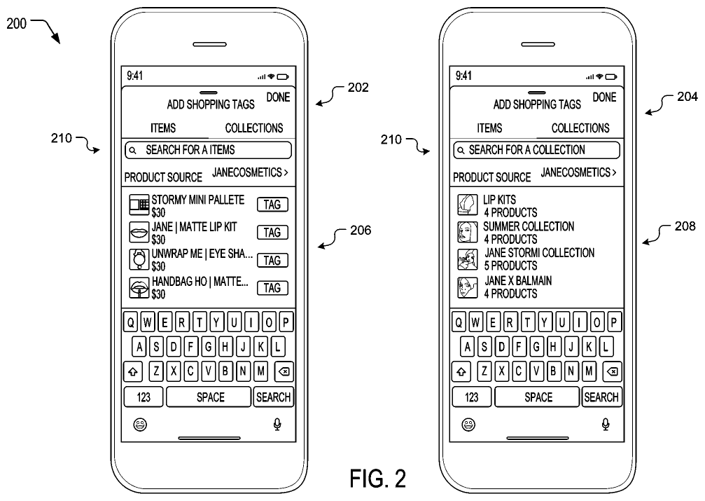

FIG. 2 is an example 200 illustrating scheduling interfaces 202 and 204 associated with scheduling a live stream event according to some implementations. In the current example 200, a host user may be scheduling or otherwise planning a live stream event for a future date. Generally, the host user may set a date and time for the live stream event. The host user may also select a topic, as well as items and/or item collections (e.g., a series of related items or items grouped by the host user) to be featured during the live stream event. In the current example 200 and as illustrated in interface 202, the host user may select items from an item selection area 206 to associate the selected items with the live stream event. Likewise, as shown with respect to interface 204, the host user may select whole collections or pre-arranged groups of items by selecting a collection from the collection selection area 208. The host user may also search for specific items or collections using the search bar 210 in either the item interface 202 or the collection interface 204.

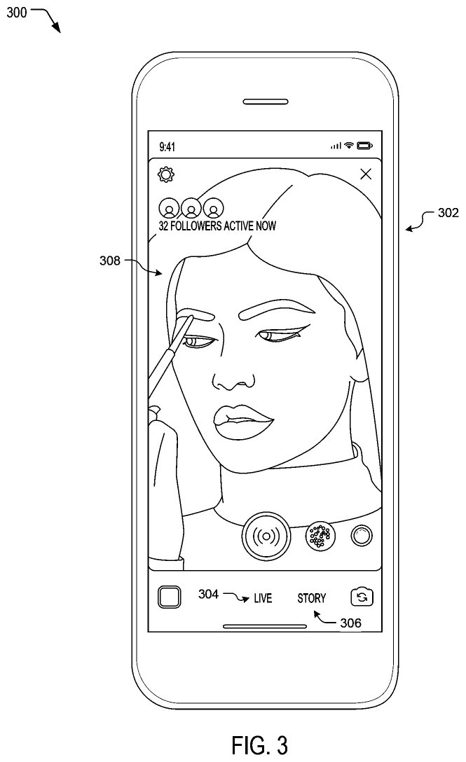

FIG. 3 is an example illustrating a streaming interface 302 associated with a live stream event according to some implementations. In the current example 300, the host user, such as host user 104 of FIG. 1, may initiate a live stream event, such as by selecting the live icon 304, or pre-record an event, such as by selecting the story icon 306. The host user may also view the image content being recorded in a content area 308, such that the host user may view the live stream content concurrently with the viewing users, such as users 102(1)-(n) of FIG. 1.

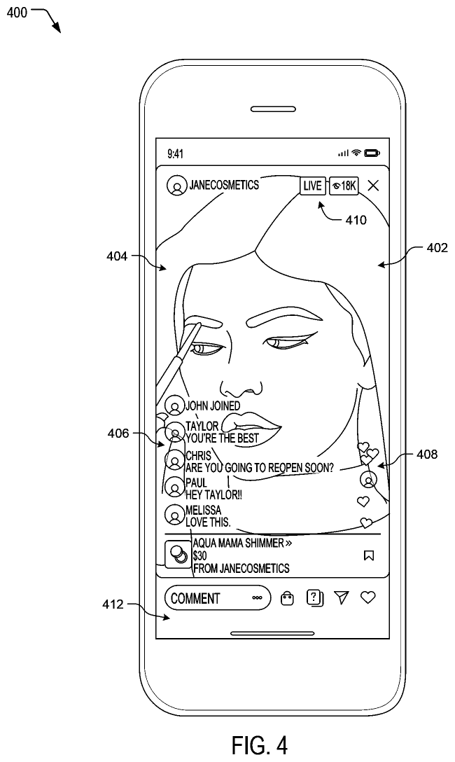

FIG. 4 is an example 400 illustrating a viewing interface 402 associated with a live stream event according to some implementations. In the current example 400, a user, such as any of the users 102(1)-(n) of FIG. 1, may view or otherwise consume the content being streamed from a device of the host user, such as user 104 of FIG. 1. In the illustrated example 400, the viewing interface 402 may include a content area 404 currently displaying an image or video of the host user applying eyebrow pencil (e.g., one of the items being featured in the live stream event).

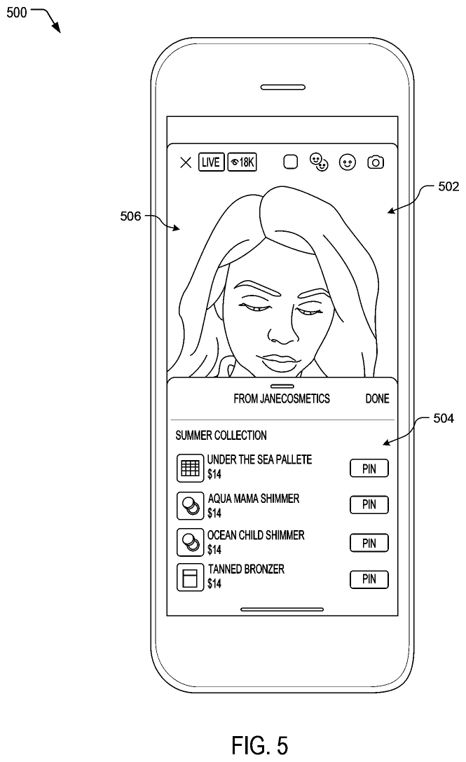

The interface 402 may also include a comments area 406, a feedback area 408, a status indictor area 410, and a user input area 412. The comments area 406 may present a feed of comments received from the users 102(1)-102(n) associated with the live stream event, the item (e.g., the eyebrow pencil), the host user, and the like. The feedback area 408 may be configured to display feedback users provide in the form of likes, dislikes, etc. The status indictor area 410 may be configured to display a status of the event (e.g., live or previously recorded) and, for instance, a number of viewers. The user input area 412 may be configured to allow the user consuming the live stream event to provide feedback to the host user and/or other viewing users, such as in the form of comments, likes, dislikes, etc. The user input area 412 may also allow the user to open a shopping interface, as discussed in more detail below with respect to FIG. 5.

FIG. 5 is an example 500 illustrating a shopping interface 502 associated with a live stream event according to some implementations. In the current example 500, a viewing or consuming user has selected to open the shopping interface 504, for instance, by selecting the shopping interface icon from the user input area 412 show above with respect to FIG. 4. As shown in the current example 500, when the shopping interface 504 is open, the display continues to display the streaming content of the event in the content area 506. For instance, in the illustrated example 500, the display may be split or otherwise separated such that a first portion of the display may present the shopping interface 504 and a second portion of the display may present the content of the live stream event concurrently with the shopping interface 504.

The shopping interface 504 may display a list of the items and/or collections selected by the host user during the scheduling or setup phase of the live stream event. In some cases, the viewing user may select or tap on the item to receive more information (such as product or item details) and/or to place the item into a shopping cart associated with the viewing user.

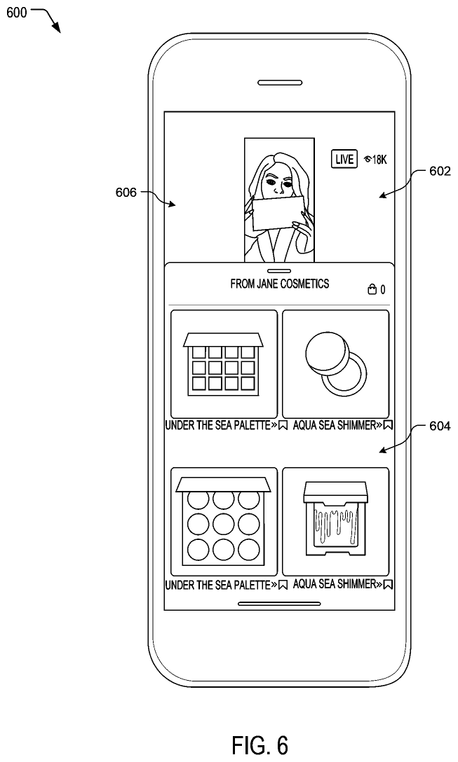

FIG. 6 is another example 600 illustrating a shopping interface 602 associated with a live stream event according to some implementations. as discussed above, a viewing or consuming user has selected to open the shopping interface 604, for instance, by selecting the shopping interface icon from the user input area 412 shown above with respect to FIG. 4. As shown in the current example 600, when the shopping interface 604 is open, the display continues to display the streaming content of the event in the content area 606. For instance, in the illustrated example 600, the display may be split or otherwise separated such that a first portion of the display may present the shopping interface 604 and a second portion of the display may present the content of the live stream event.

The shopping interface 604 may display a list of the icons representing the items and/or collections selected by the host user during the scheduling or setup phase of the live stream event. Again, in some cases, the viewing user may select or tap on the item to receive more information (such as product or item details) and/or to place the item into a shopping cart associated with the viewing user.

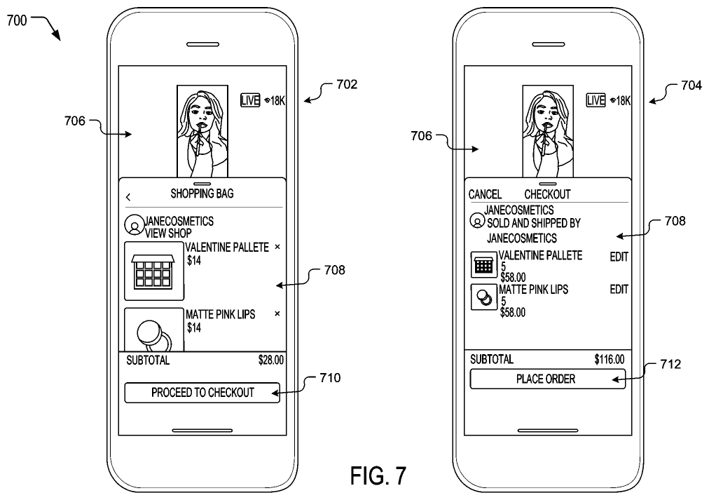

FIG. 7 is an example 700 illustrating shopping interfaces 702 and 704 associated with a live stream event according to some implementations. In the illustrated example 700, the shopping cart interface 702 may include a shopping cart or bag that lists items selected by the viewing user during the live stream event. In the current example, the streaming content displayed in the content area 706 may be re-sized or configured to fit within the reduced display area assigned to the live stream event. Additionally, in the example 700 the interfaces 702 and 704 each include a shopping area 708 (e.g., a second portion of the display separate from the content area 704). In the shopping interface 702, the shopping area 708 may display items or collections the user has placed into a shopping bag with the intent to purchase. When the viewing or consuming user is ready to checkout, the viewing user may select the checkout icon 710. The shopping interface 704 illustrates the checkout process in which the user may place the order for the items or collections from a third-party vendor via the place order icon 712.

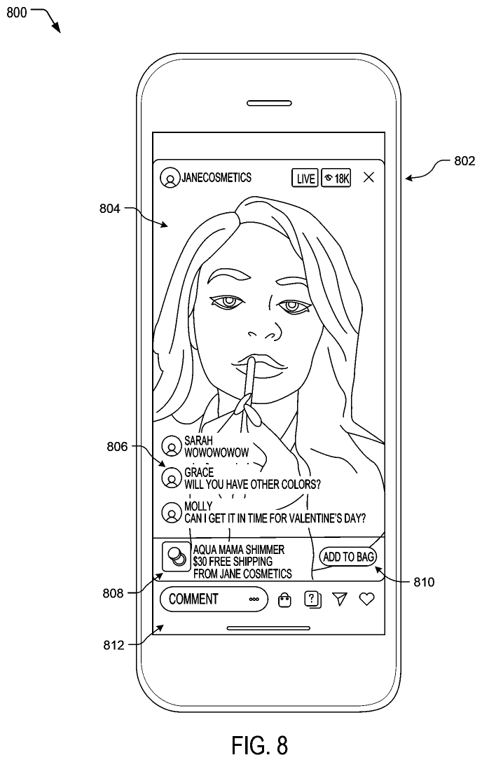

FIG. 8 is an example 800 illustrating a viewing interface 802 associated with a live stream event according to some implementations. In the current example, the viewing user is consuming the live stream content, via the content area 804 and other user's comments and feedback may be displayed in the comments area 806, as discussed above. However, in the example 800, an item highlighted area 808 may be displayed below the comment area 806 and above the interactive area 812. The item highlight area 808 may display an item or collection that the host user has highlighted or selected to be displayed during the live stream event. For instance, if the host user begins to discuss and demonstrate the use of a particular type of shimmer, the host user may select the item to be highlighted for the viewing users while the host user discusses the shimmer. This highlighted item (e.g., the shimmer) may be displayed to the viewing users within the item highlight area 808 to provide an indication of the item currently on display, provide information related to the item (e.g., the source, cost, product details, and the like), as well as a selectable icon 810 to place the item directly in the shopping bag of the user (e.g., without requiring the user to view a different user interface and/or leave the live stream). In examples, the shopping bag may be accessed via the shopping interface as discussed above to view the item placed in the shopping bag using the selectable icon 810.

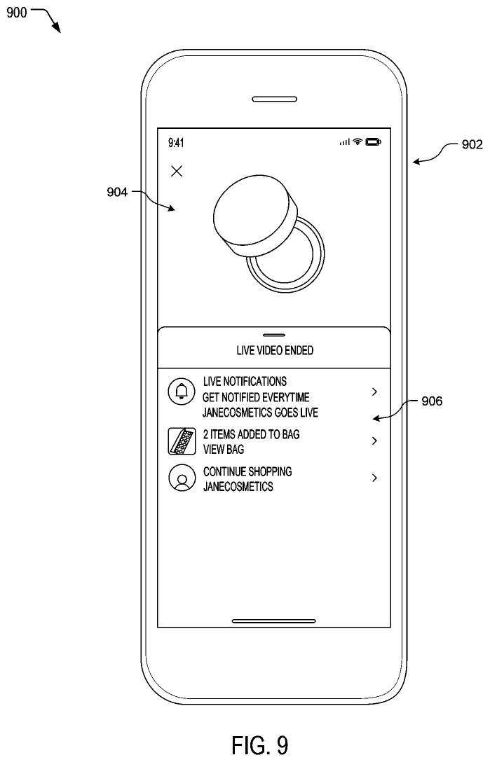

FIG. 9 is an example 900 illustrating an event summary interface 902 associated with a live stream event according to some implementations. In some cases, the social networking system may be configured to provide a summary of a viewing user's interactions with the live stream event once the event has ended (and/or prior to the event ending). In the example 900, the social networking system may cause the event summary interface 902 to display an icon or image representative of the live stream event within the content area 904. In the example 900, an icon of the shimmer or one of the items/collections highlighted by the host user discussed during the live stream event may be selected. In the summary area 906, the social networking system may cause a list of interactions between the viewing user and the social networking system to be displayed. For instance, in the example 900, the viewing user may have added two items to their bag during the live stream event. In this example 900, the social networking system may also invite the viewing user to sign up for additional live stream events associated with the host user and/or to continue shopping the items/collections from the current live stream event.

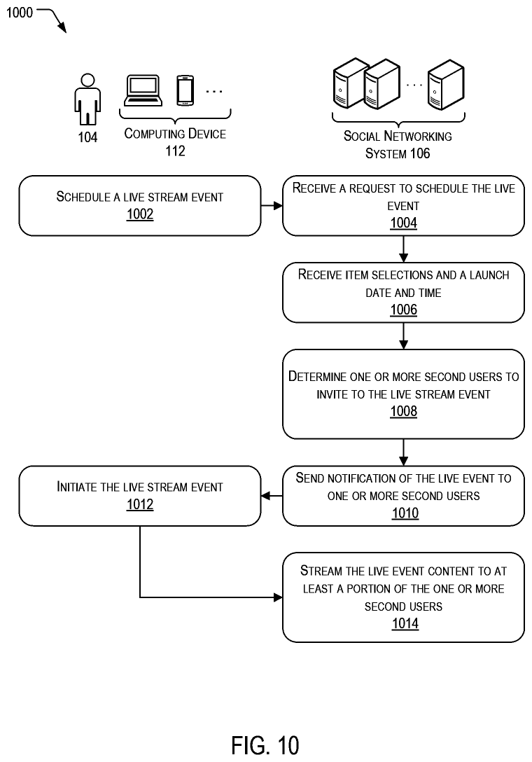

FIGS. 10-12 are flow diagrams illustrating example processes associated with the live stream events as discussed above. The processes are illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, which when executed by one or more processors, perform the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 10 is a flow diagram illustrating an example process 1000 for initiating a live stream event via the social networking system, such as the social networking system 106 of FIG. 1, according to some implementations. As discussed above, a host user, such as the host user 104 of FIG. 1, conducts or hosts live stream events via the social networking system 106 to promote a topic as well as items or collections of items for purchase by the other users of the social networking system 106. In these examples, the social networking system 106 may be configured to allow for a continuous or uninterrupted consumption of the streamed content while the viewing user is able to shop or otherwise purchase the promoted items or collections.

At 1002, the host user 104 may schedule the live stream event. For example, the host user 104 may determine a time and date associated with the live stream event. The host user 104 may also select one or more topics, items, collections of items, and the like to be featured in regard to the lives stream event. In some cases, the host user 104 may also indicate a set or subset of users of the social networking system 106 to invite to the live stream event. For instance, the host user 104 may select one or more friends, followers, or other users that are related to the host user 104 to receive an invitation to the live stream event.

At 1004, the social networking system 106 may receive the request to schedule the live stream event and, at 1006, the social networking system 106 may receive item selections and a launch date and time for the live stream event. In some cases, the item selections and/or the launch date/time may be received with the request to schedule the live stream event, while in other cases, the host user 104 may make item selections, add items to the event, remove items from the event, and the like at a later time prior to the launch date and time but after sending the request to schedule the event.

At 1008, the social networking system 106 may determine one or more second users to invite to the live stream event. For example, the social networking system 106 may invite users indicated by the host user during the scheduling process. The social network system 106 may also identify other users of the social networking system 106 that may be interested in or are likely to attend the live stream event. For example, the social networking system 106 may identify the second users based on features associated with the host user 104 (e.g., users that have followed, liked, or consumed the content of the host user, and the like), features associated with the second users (e.g., historical data, historical content consumptions, known likes or dislikes, past purchasing behavior, likelihood to purchase the item, and the like), the times or topics selected for the live stream event, time/day of the event (e.g., weekday v. weekend, after work hours based on a user's current time zone, and the like), etc.

At 1010, the social networking system 106 may send notifications of the live event to the one or more second users. For example, the social network system 106 may then send a notification to the identified or selected second users indicating or including a link to access the live stream event as well as information related to the topic, items, host user 104, and stream date and time. In some cases, the notifications may allow the second users to bookmark, set reminders, and otherwise share or invite additional users to the live stream event.

At 1012, the host user 104 may initiate the live stream event. For example, the host user 104 may initiate the live stream event by providing a user input and/or initiating an image and/or audio capture via one or more devices, such as the computing device 112. In other cases, the social networking system 106 may assist with or cause the live stream event to commence, such as in response to a trigger associated with the start time and date.

At 1014, the social networking system 106 may stream the live event content (e.g., the image and/or audio data captured by the computing device 112 of the host user 104) to at least a portion of the one or more second users 1014. For example, the social networking system 106 may stream the live event content to any user that has selected, via a user input, to access the live stream event content. In some cases, individual users of the one or more second users that fail to access the live stream event at the scheduled time and date, the social networking system 106 may send a reminder, alert, or additional notification that the live stream event is commencing.

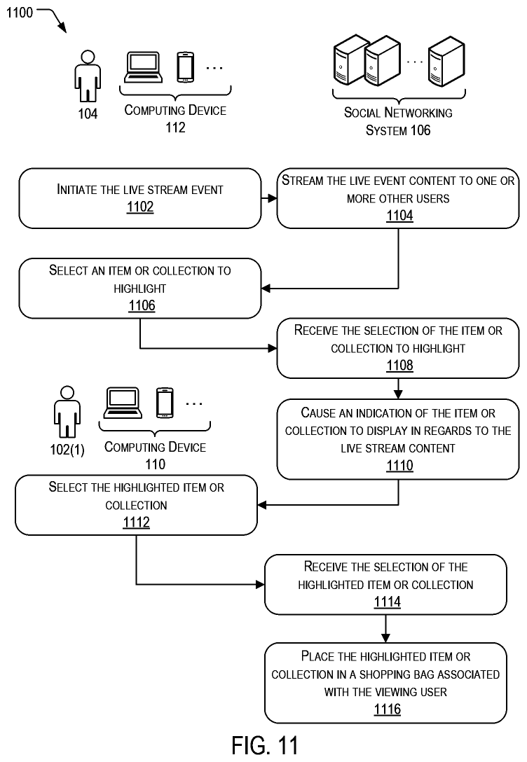

FIG. 11 is a flow diagram illustrating an example process 1100 associated with a host user, such as the host user 104 of FIG. 1, highlighting an item featured in a live stream event, according to some implementations. As discussed above, the host user 104 conducts or hosts live stream events via the social networking system, such as social networking system 106 of FIG. 1, to promote a topic as well as items or collections of items for purchase by the other users of the social networking system 106. In these examples, the social networking system 106 may be configured to allow a host user 104 to highlight or otherwise cause an item to be presented on a display of a viewing user, such as the viewing user 102(1) of FIG. 1, while the viewing user 102(1) consumes a continuous or uninterrupted streamed of content from the host user 104.

At 1102, the host user 104 may initiate the live stream event. For example, the host user 104 may initiate the live stream event by providing a user input and/or initiating an image and/or audio capture via one or more devices, such as the computing device 112. In other cases, the social networking system 106 may assist with or cause the live stream event to commence, such as in response to a trigger associated with the start time and date.

At 1104, the social networking system 106 may stream the live event content (e.g., the image and/or audio data captured by the computing device 112 of the host user 104) to one or more other users including the viewing user 102(1). For example, the social networking system 106 may stream the live event content to any user that has selected, via a user input, to access the live stream event content. In some cases, individual users of the one or more second users that fail to access the live stream event at the scheduled time and date, the social networking system 106 may send a reminder, alert, or additional notification that the live stream event is commencing.

At 1106, the host user 104 may provide a user input to select an item or collection to highlight for the viewing users. For example, the host user 104 may begin to discuss or demonstrate a particular item or collection during a particular portion of the live stream event. The host user 104 may also select the particular item or collection from a list of pre-populated items or collections the host user 104 arranged prior to the live stream event.

At 1108, the social networking system 106 may receive the selection of the item or collection to highlight and, at 1110, the social networking system may cause an indication of the item or collection to display in regards to the live stream content.

At 1112, a computing device, such as computing device 110 of FIG. 1, associated with a viewing user, such as viewing user 102(1) of FIG. 1, may receive a selection of the highlighted item or collection from the viewing user 102(1). For instance, the computing device 110 may receive the live stream content and data associated with the highlighted item or collection. The data associated with the highlighted item or collection may include product information, product images, product price, seller or product source, and the like. The computing device 110 may display the data associated with the highlighted item or collection in conjunction or substantially concurrently with the live stream content.

At 1114, the social networking system 106 may receive the selection of the highlighted item or collection from the computing device 110 associated with the viewing user 102(1) and, in response, at 1116 the social networking system 106 may place the item or collection in a shopping bag associated with the viewing user 102(1). In some cases, the viewing user 102(1) may then complete a purchase of the highlighted item or collection during the live stream event or at a time after the event has expired.

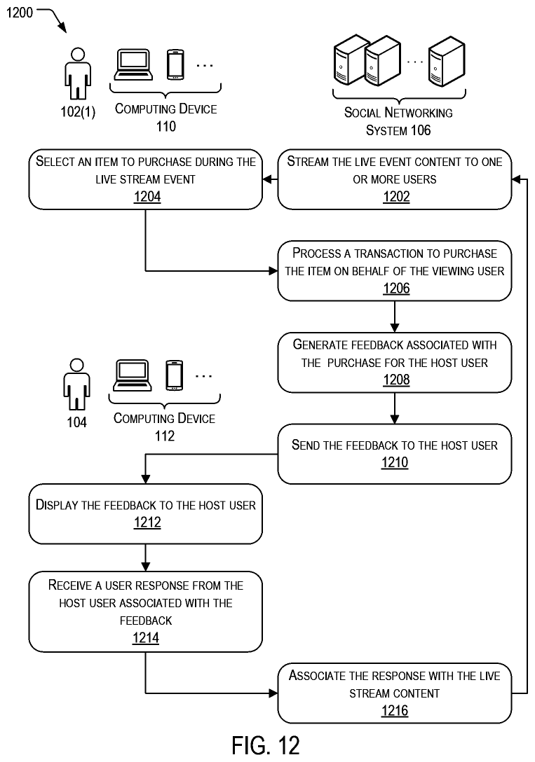

FIG. 12 is a flow diagram illustrating an example process 1200 associated with a host user, such as the host user 104 of FIG. 1, recognizing viewing users, such as the viewing user 102(1) of FIG. 1, during a live stream event, according to some implementations. In the current example, the host user 104 may be in the process of streaming content associated with the live stream event to a plurality of users including the viewing user 102 via a social networking system, such as the social networking system 106 of FIG. 1.

At 1202, the social networking system 106 may stream the live event content (e.g., the image and/or audio data captured by the computing device 112 of the host user 104) to one or more other users (e.g., the other users' computing devices) including the viewing user 102(1). For example, the social networking system 106 may stream the live event content to any user that has selected, via a user input, to access the live stream event content.

At 1204, the viewing user 102(1) may select an item (or collection) to purchase during the live stream event via a computing device, such as the computing device 110 of FIG. 1. For example, the viewing user 102(1) may select an item or collection from the item highlight area and/or the shopping interface, as discussed above with respect to FIGS. 7 and 8.

At 1206, the social networking system 106 may process a transaction to purchase the item (or collection) on behalf of the viewing user 102(1). For instance, the social networking system 106 may place an order for the item at a third-party retailer or venue on behalf of the user 102(1) to initiate a shipping or delivery phase of the transaction.

At 1208, the social networking system 106 may generate feedback associated with the purchase for the host user 104. For example, the social networking system 106 may aggregate data associated with a number of purchase events associated with the live stream event. The aggregated data may include the number of purchases associated with individual users, a total purchase price associated with individual users, a number of live stream events associated with the host user 104 attended by an individual users, a purchase history associated with individual users, a number of comments associated with individual user, a content of the comments associated with the user, and the like. The social networking system 106 may then filter or select feedback to provide to the host user 104 based on the aggregated data. The social networking system 106 may select particular interactions, comments, purchase, and the like based on the aggerated data to send to the host user 104.

For instance, the social networking system 106 may select purchases events having the largest total sales amount, the largest number of items purchased, the largest number of unique items purchased, or the like to emphasis for the host user 104. In another instance, the social networking system 106 may select interactions of a user to emphasis based on a reoccurrence of the user purchasing items during the live stream event (e.g., interaction of users that regularly attend the live stream events and purchase items or collections), content of the comments, number of comments by a user, a number of event shares, and the like.

At 1210, the computing device 112 associated with the host user 104 may display, to the host user 104, the feedback selected by the social networking system 106. For example, the social network system 106 may send an indication or instruction to cause the device 112 to display the feedback to the host user 104 during the live stream event. In some cases, the device 112 may display an identifier associated with the viewing user 102(1) and an indication of the purchase event.

The feedback displayed to the host user 104 may also include, for instance, a frequency of attendance of the viewing user 102(1) with respect to the live stream events of the host user 104, a metric associated with historical purchases of the by the viewing user 102(1), a total cost of the items purchased during the live stream event, a number of other users invited and/or attending the live stream event by the viewing user 102(1), and the like. In one specific example, the feedback may be coded (such as color coded) so that the host user 104 can quickly comprehend the status of the feedback and respond while continuing to conduct the live stream event. For example, positive feedback may be green while negative feedback may be red, and the like.

At 1214, the device 112 may receive a user response from the host user 104 associated with the feedback. For instance, in response to displaying the feedback the host user 104 may select the feedback. In response, the device 112 and/or the social networking system 106 may associated the selection with a pre-prepared response, such as “thank you user X for your purchase” that will be displayed in the comment area of the live stream event for the viewing audience to see. In this manner, the host user 104 may in substantially real-time acknowledge or otherwise recognize users for interactions with the live stream event. In some implementations, the host user 104 may have a list of pre-prepared responses and upon the selection of the feedback, the device 112 may present the pre-prepared response for the host user 104. In other cases, the device 112 and/or the social networking system 106 may select one of the pre-prepared responses on behalf of the host user 104.

At 1216, the social networking system 106 may associate the response with the live stream content. For example, the social networking system 106 may add the response to the comment area of the live stream event. In other cases, the social networking system 106 may highlight or otherwise emphases the host user 104 response so that the response stand out from other comments by other viewing users. The process 1200 may then return to 1202 and the social networking system may continue to stream the live event content.

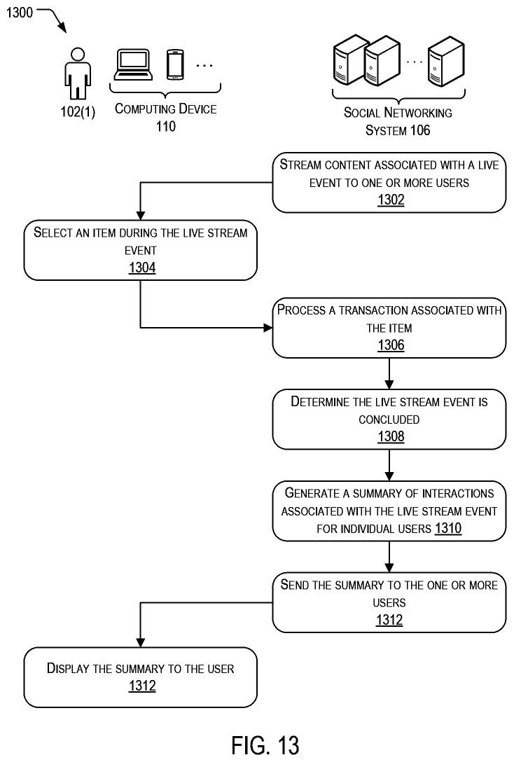

FIG. 13 is a flow diagram illustrating an example process 1300 associated with a viewing user, such as the user 102(1) of FIG. 1, consuming live stream event content via a computing device, such as the computing device 110 of FIG. 1, according to some implementations. As discussed above, the viewing user 102(1) may consume live stream event content while engaging with a shopping interface to purchase items and/or collections via a social networking system, such as the social networking system 106 of FIG. 1. The social networking system 106 may process the transaction during the live stream event and provide the user 102(1) with a summary upon the conclusion of the live stream event.

At 1302, the social networking system 106 may stream content associated with a live stream event to one or more users. For example, the content may be streamed from a host user device capturing sensor data to devices, such as device 110, of the viewing users, such as user 102(1). In some cases, the live stream content may include image data, audio data, text data, and the like.

At 1304, the user 102(1) may select, via the computing device 110, an item (or collection) during the live stream event. For example, the item (or collection) may be featured by the host user during the live stream. In some cases, the item (or collection) may be available for purchase from one or more third-party retailers or venues during the live stream event.

At 1306, the social networking system 106 may process a transaction associated with the item (or collection). For example, the user 102(1) may place the item into a shopping bag or cart associated or linked to the account of the user 102(1). The user 102(1) may also complete a purchase via the social networking system 106, as discussed above.

At 1308, the social networking system 106 may determine the live stream event is concluded or otherwise completed. For example, the host user may end the recording to complete the event. In other cases, the event may stream for a predetermined period of time and the social networking system 106 may conclude the live stream event when the predetermined period of time expires.

At 1310, the social networking system 106 may generate a summary of interactions associated with the live stream event for individual users. The summary may be unique for each viewing user and summarize each user's interactions with the social networking system 106 during the live stream event. For example, the social networking system 106 may generate a summary for the user 102(1) including the selection and transaction associated with the item of steps 1304 and 1306. The summary may also include any comments, feedback, other item selections, and other purchases made by the user 102(1) via the social networking system 106 during the live stream event.

At 1312, the social networking system 106 may send the summary to the one or more users (e.g., the viewing users). For example, the social networking system 106 may send the summary associated with the user 102(1) to the computing device 110 or a location accessible to the computing device 110, such as via an account of the user 102(1) with the social networking system 106.

At 1314, the computing device 110 may display the summary to the user 102(1). The user 102(1) may be able to complete pending transactions (e.g., purchase items or collections placed in a shopping bag associated with the user 102(1)), review information on the featured items or collections, sign up for another live stream event associated with the host user, and the like from the summary In some cases, the summary may include statistical data, such as number of viewers, length of the live stream event, number and identity of items/collections features, any items or collections highlighted by the host user during the live stream event, and the like.

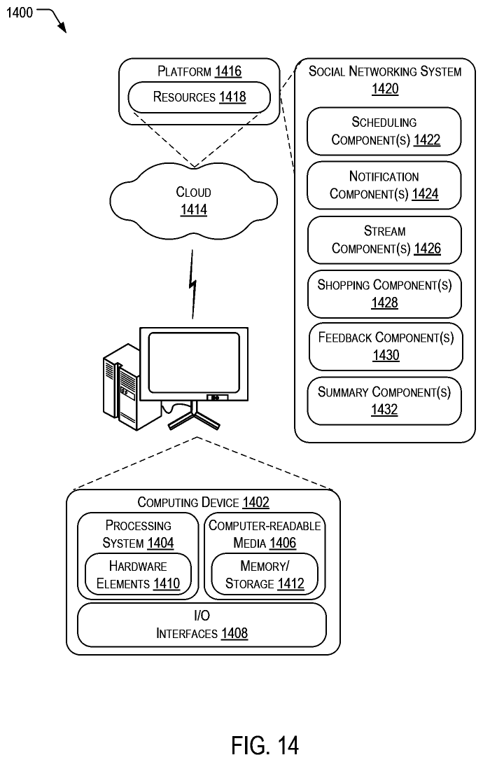

FIG. 14 illustrates an example system generally at 1400 that includes an example computing device 1402 that is representative of one or more computing systems and/or devices that may implement the various techniques described herein. This is illustrated through inclusion of a social networking system 1420 comprising a scheduling component 1422, a notification component 1424, a stream component 1426, a shopping component 1428, a feedback component 1430, and a summary component 1432.

The scheduling component 1422 may be configured to allow a host user to schedule a live stream event via the social networking system 1420. For example, the host user may be able to set a time and date for the lives stream event as well as to select featured items and/or collections that will be discussed and available to purchase during the live stream event.

The notification component 1424 may be configured to send alerts and/or notifications to users in response to the host user scheduling a live stream event via the social networking system 1422. For example, the notifications may include access information for the users to access the live stream, sharing instructions, time of event, as well as other event information (such as the topic or items associated therewith).

The stream component 1426 may allow the host user to stream event content to devices associated with viewing users and to allow the viewing users to interact with the social networking system 106.

The shopping component 1428 may allow the viewing users to place the items into the shopping chart via the shopping interface and to subsequently purchase the items. In this example, the viewing users may both add the items to a personal shopping cart and to complete a purchase event via the social networking system 106 while continuously consuming the live stream event.

The feedback component 1430 may be configured to provide feedback to the host user during the live stream event. For example, the feedback component 1420 may notify the host user as to a viewing users providing a comment, placing an item or collection in a shopping bag, purchasing an item or collection, and the like. The feedback component 1430 may also allow the host users to respond to the feedback of particular users via pre-assigned response messages that may be displayed in the comment sections of the live stream event for the general viewing public. In some cases, the host user may also be able to send a private thank you or message to a viewing users in response to the feedback.

The summary component 1432 may be configured to generate a summary of the interactions with the social networking system 1420 of each viewing user during each live stream event. The summary may also allow a viewing user to complete transactions associated with the live stream event, sign up for other related live stream events (e.g., similar topic, features items, or host user), and the like. In one example, the summary component 1432 may also allow the viewing users to rate the host user and/or the live stream event.

The computing device 1402 may be, for example, a server of a service provider, a device associated with a client (e.g., a client device), an on-chip system, and/or any other suitable computing device or computing system. The example computing device 1402 as illustrated includes a processing system 1404, one or more computer-readable media 1406, and one or more I/O interfaces 1408 that are communicatively coupled, one to another. Although not shown, the computing device 1402 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1404 is representative of functionality to perform one or more operations using hardware. Accordingly, the processing system 1404 is illustrated as including hardware elements 1410 that may be configured as processors, functional blocks, and so forth. This may include implementation in hardware as an application specific integrated circuit or other logic device formed using one or more semiconductors. The hardware elements 1410 are not limited by the materials from which they are formed, or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1406 is illustrated as including memory/storage 1412. The memory/storage 1412 represents memory/storage capacity associated with one or more computer-readable media. The memory/storage component 1412 may include volatile media (such as random access memory (RAM)) and/or nonvolatile media (such as read only memory (ROM), Flash memory, optical disks, magnetic disks, and so forth). The memory/storage component 1412 may include fixed media (e.g., RAM, ROM, a fixed hard drive, and so on) as well as removable media (e.g., Flash memory, a removable hard drive, an optical disc, and so forth). The computer-readable media 1406 may be configured in a variety of other ways as further described below.

Input/output interface(s) 1408 are representative of functionality to allow a user to enter commands and information to computing device 1402, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1402 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “logic,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on and/or transmitted across some form of computer-readable media. The computer-readable media may include a variety of media that may be accessed by the computing device 1402. By way of example, and not limitation, computer-readable media may include “computer-readable storage media” and “computer-readable transmission media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer-readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable transmission media” may refer to a medium that is configured to transmit instructions to the hardware of the computing device 1402, such as via a network. Computer-readable transmission media typically may transmit computer-readable instructions, data structures, program modules, or other data in a modulated data signal, such as carrier waves, data signals, or other transport mechanism. Computer-readable transmission media also includes any information delivery media. The term “modulated data signal” means a signal that has one or more of its characteristics set or changed in such a manner as to encode information in the signal. By way of example, and not limitation, computer-readable transmission media include wired media such as a wired network or direct-wired connection, and wireless media such as acoustic, radio frequency (RF), infrared, and other wireless media.

As previously described, hardware elements 1410 and computer-readable media 1406 are representative of modules, programmable device logic and/or device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1410. The computing device 1402 may be configured to implement particular instructions and/or functions corresponding to the software and/or hardware modules. Accordingly, implementation of a module that is executable by the computing device 1402 as software may be achieved at least partially in hardware, e.g., through use of computer-readable storage media and/or hardware elements 1410 of the processing system 1404. The instructions and/or functions may be executable/operable by one or more articles of manufacture (for example, one or more computing devices 1402 and/or processing systems 1404) to implement techniques, modules, and examples described herein.

The techniques described herein may be supported by various configurations of the computing device 1402 and are not limited to the specific examples of the techniques described herein. This functionality may also be implemented all or in part through use of a distributed system, such as over a “cloud” 1414 via a platform 1416 as described below.

The cloud 1414 includes and/or is representative of a platform 1416 for resources 1418. The platform 1416 abstracts underlying functionality of hardware (e.g., servers) and software resources of the cloud 1414. The resources 1418 may include applications and/or data that can be utilized while computer processing is executed on servers that are remote from the computing device 1402. Resources 1418 can also include services provided over the Internet and/or through a subscriber network, such as a cellular or Wi-Fi network.

The platform 1416 may abstract resources and functions to connect the computing device 702 with other computing devices. The platform 1416 may also be scalable to provide a corresponding level of scale to encountered demand for the resources 1418 that are implemented via the platform 1416. Accordingly, in an interconnected device embodiment, implementation of functionality described herein may be distributed throughout multiple devices of the system 1400. For example, the functionality may be implemented in part on the computing device 1402 as well as via the platform 1416 which may represent a cloud computing environment 1414.

### CONCLUSION

Although the discussion above sets forth example implementations of the described techniques, other architectures may be used to implement the described functionality and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
receiving, from a first user device associated with a first user account, scheduling data associated with a live stream event, the scheduling data including at least a date, a time, and an item to be featured during the live stream event;
identifying a second user account to invite to the live stream event;
sending a notification to a second user device associated with the second user account;
streaming live stream event data from the first computing device to the second computing device in response to determining the live stream event has commenced;
receiving from the second user device a first interaction with the social networking system, the first interaction to cause a shopping interface to be displayed concurrently with the live stream event data on a graphical element of the second computing device;
receiving from the second user device a second interaction with the social networking system, the second interaction to cause initiate a purchase of the item with a third-party retailer;
processing a transaction with the third-party retailer on behalf of the second user account to complete the purchase of the item;
sending a notification to the first computing device, the notification to cause feedback data associated with the transaction to display on a graphical element of the first computing device;
receiving, from the first computing device, a request to recognize the second user account; and
sending a pre-prepared response to at least the second computing device and a third computing device to cause the pre-prepared response to be displayed concurrently with the live stream data on the graphical element of the second computing device and a graphical element of the third computing device.

2. The method of claim 1, wherein the pre-prepared response is received from the first computing device as part of the scheduling data.

3. The method of claim 1, further comprising:
generating a summary of interactions associated with the second user account with the social networking systems during the live stream event; and
sending the summary of the interactions to the second computing device.

4. The method of claim 1, wherein the notification includes a description of the item, the date, the time, and selectable icon to access the live stream event.

5. The method of claim 1, further comprising:
receiving a request from the first computing device to highlight the item; and
sending item data to at least the second computing device and the third computing device to cause the item data to be displayed concurrently with the live stream data on the graphical element of the second computing device and the graphical element of the third computing device.

6. One or more non-transitory computer-readable media storing instructions that, when executed by one or more processors, cause one or more computing devices to perform operations comprising:
receiving, from a first user account, scheduling data associated with a live stream event, the scheduling data including a first item to be featured during the live stream event;
streaming live stream event data to a second user account;
receiving from the second user account a request to access a shopping interface associated with the live stream event data; and
providing the live stream event data and shopping interface data to the second user account to cause the shopping interface data to be displayed on a device associated with the second user account concurrently with the live stream event data.

7. The one or more non-transitory computer-readable media as recited in claim 6, wherein the operations further comprise:
identifying one or more additional user accounts to invite to the live stream event; and
sending a notification to the one or more additional user accounts.

8. The one or more non-transitory computer-readable media as recited in claim 7, wherein the notification includes a selectable icon that, when selected, causes individual ones of the one or more second user accounts to share the notification with an additional user account of the social networking system.

9. The one or more non-transitory computer-readable media as recited in claim 6, the operations further comprising:
receiving from the device a request to purchase the first item;
processing a transaction to purchase the item with a third-party retailer on behalf of the second user account; and
sending transaction data associated with the transaction to purchase the item to the device to cause the transaction data to be displayed concurrently with the live stream event data.

10. The one or more non-transitory computer-readable media as recited in claim 9, wherein the device is a first device and the operations further comprising:
sending an indication of the transaction associated with the transaction data to a second device associated with the first user account to cause the indication to be displayed on a graphical element of the second device.

11. The one or more non-transitory computer-readable media as recited in claim 10, the operations further comprising:
receiving a request to recognize the second user account from the second device; and
sending a pre-prepared response to the first device to cause the pre-prepared response to be displayed concurrently with the live stream data.

12. The one or more non-transitory computer-readable media as recited in claim 11, the operations further comprising:
sending the pre-prepared response to a third device associated with a third user to cause the pre-prepared response to be displayed concurrently with the live stream data.

13. The one or more non-transitory computer-readable media as recited in claim 11, wherein:
the scheduling data includes a plurality of pre-prepared responses; and
the operations further comprise selecting the pre-prepared response from the plurality of pre-prepared responses.

14. A computing device comprising:
a display;
one or more processors; and
one or more computer-readable media storing instructions that, when executed by the one or more processors, cause the one or more processors to perform operations comprising:
receiving, at a first user account associated with the device, live stream event data from a social networking system, the live stream event data associated with a second user account;
presenting the live stream event data on the display; and
concurrently presenting the live stream event data and a shopping interface on the display in response to receiving an input to access a shopping interface during the live stream event.

15. The computing device of claim 14, the operations further comprising:
receiving a first selection of a first item via the shopping interface;
adding a first item to a shopping bag associated with the first user account;
receiving a second selection to access the shopping bag; and
concurrently presenting the live stream event data and the shopping bag on the display during the live stream event.

16. The computing device as recited in claim 15, wherein the operations further comprise:
receiving a third selection to purchase the first item;
sending a request to the social networking system to purchase the first item;
receiving a confirmation that the first item was purchased; and
concurrently presenting the live stream event data and the confirmation on the display during the live stream event.

17. The system of claim 15, wherein the operations further comprise:
receiving response data from the social networking system, the response data associated with the host device; and
concurrently presenting the live stream event data and the response data the display during the live stream event.

18. The system of claim 15, wherein the response data comprise one or more text-based comments pre-configured and associated with the first user account.

19. The system of claim 14, wherein the operations further comprise:
receiving comment data from the social networking system; and
concurrently presenting the live stream event data and the comment data the display during the live stream event.

20. The system of claim 14, wherein the operations further comprise:
receiving highlight data associated with an item to feature during presentation of the live stream event data from the social networking system; and
concurrently presenting the live stream event data and the highlight data the display during the live stream event.
